(19) United States
(12) Patent Application Publication
(10) Pub. No.: US 2015/0178477 A1
(43) Pub. Date: Jun. 25, 2015

(54) Data Collection Privacy Agent to Ensure, Absent an Agreement, that Only Public Standards are Collected, and to Package Private Data Exclusively for Intended Recipients

(71) Applicants: BRUCE BLAINE LACEY, FOSTER CITY, CA (US); Ellis Wong, Lexington, MA (US)

(72) Inventors: BRUCE BLAINE LACEY, FOSTER CITY, CA (US); Ellis Wong, Lexington, MA (US)

(73) Assignee: CARRIER IQ, INC., Sunnyvale, CA (US)

(21) Appl. No.: 14/140,504

(22) Filed: Dec. 25, 2013

(51) Int. Cl. G06F 21/10

(52) U.S. Cl. CPC G06F 21/10

(57) ABSTRACT

A system protects a mobile wireless device owner/user who has entered into a private data collection agreement with a service provider or subscribed as a survey participant. The system enables each survey or service to define a profile, which contains triggers, data to be collected, conditions to package it, and targets to receive packages. Embedded within the user's device, a data collection privacy agent verifies the owner/user's permission for each profile. When a permitted privacy agent is triggered, it stores the data to be collected upon each specific trigger condition or event. Upon determining a condition to package collected data, the permitted privacy agent compiles a package containing only the data related to a permitted profile sourced from an authenticated survey or service, encrypts it, transmits the encrypted package to a target defined within the profile, and reallocates any storage space which is no longer needed.

### RELATED APPLICATIONS

Not Applicable.

### BACKGROUND OF THE INVENTION

In order to have mobile wireless communication operable, certain standards must be followed to provide connectivity. However, additional value added services and capabilities may depend on conscious subscription or agreement. In addition, survey hosts compensate mobile users to participate in programs.

One concern is the unauthorized collection and misuse of data recorded on mobile wireless devices by malefactors, commercial information brokers, and governments.

Many beneficial services are offered to users, which take advantage of new features of the devices and their communications infrastructure, yet their utilization may result in surprising unanticipated side-effects and consequences.

Thus it can be appreciated that what is needed is improved control by a device user/owner of which data is collected and to whom it is entrusted.

### SUMMARY OF THE INVENTION

A general problem that arises in mobile wireless electronics is a lack of clarity on what is public information and what may be considered personal or private. With increasing pervasiveness of social networking and connectedness, the boundary is evolving. The present invention enables users with changing attitudes to adjust their participation in sharing content that they are generating consciously or unconsciously.

A privileged data collection privacy agent has exclusive access to certain non-user measurement information within a mobile wireless device. When a mobile wireless device owner/user has entered into a private data collection agreement with a service provider or subscribed as a survey participant he or she receives a profile from the survey or service. Each profile contains triggers, data to be collected, conditions to package it, and targets to receive packages. The data collection privacy agent examines all profiles installed at the device.

A data collection privacy agent confirms that the owner/user has granted permission to each profile. The data collection privacy agent determines a superset of triggers, and upon recognizing each trigger event, stores the data, which has been agreed to be collected. Data is examined to determine if it is not to be collected and is discarded. Upon determining a condition to package collected data, the data collection agent compiles a package of only the data related to a certain profile provided by a certain survey or service.

Additional interactive or automated steps may ensure that the agreement to provide data is still valid. The data collection privacy agent encrypts it, and transmits the encrypted package to a target defined within a profile. In embodiments, the data collection privacy agent reallocates storage space, which is no longer needed or actively writes over the space when no other profile requires the data.

A system protects a mobile wireless device owner/user who has entered into a private data collection agreement with a service provider or subscribed as a survey participant. The system enables each survey or service to define a profile, which contains triggers, data to be collected, conditions to package it, and targets to receive packages.

Embedded within the user's device, a data collection privacy agent verifies the owner/user's permission for each profile. When a permitted privacy agent is triggered, it stores the data to be collected upon each specific trigger condition or event. Upon determining a condition to package collected data, the permitted privacy agent compiles a package containing only the data related to a permitted profile sourced from an authenticated survey or service, encrypts it, transmits the encrypted package to a target defined within the profile, and reallocates any storage space which is no longer needed.

### BRIEF DESCRIPTION OF DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of an exemplary computer system;

FIG. 2 is a block diagram of a mobile wireless device, which is controlled by a data collection privacy agent.

FIG. 3 is a flow chart of steps in a process performed by a processor of a mobile wireless device.

### DETAILED DISCLOSURE OF EMBODIMENTS

Members of the supply chain or service ecosphere which goes to market with mobile wireless devices may negotiate various terms and conditions to retain a degree of relationship with an eventual enduser. Of course the last step in the service/supply chain may override all prior agreements at the risk of having poor support or follow-on product availability. But it may be in the interest of all parties to act cooperatively in adding value and sharing after sale information or even revenue for support.

Users increasingly wish to control their privacy and have the power to select which entities have access to data recorded on their personal devices.

Operating systems for mobile wireless devices must have one or more levels of privileged access. User entered data is of course entirely the users. But there is data about the ecosphere that may be minimized to provide standard communication services and other data that may be selectively shared or segregated.

In the current application we define a data collection privacy agent which has privileged access to measurements of the device but not to user entered data unless specifically enabled by the user/owner. A user/owner engages a service or survey entity which prepares according to their agreement a privacy profile which contains triggers, data to be collected, packages to be compiled, and destinations to which the device will transmit the agreed packages of data.

In embodiments the device will check with a clearinghouse or with the user if the agreement is still in place before transmitting a package. Data may be collected for multiple profiles and transmitted in different packages. When all recipients have gotten delivery, the data can be purged from the device or the storage location can be simply reallocated as free space. Packages for different destinations will be encrypted differently, e.g. from different seeds.

One aspect of the invention is a method for operation of a data collection privacy agent on a mobile wireless device whose owner/user has entered into a private data collection agreement with a service provider or subscribed as a survey participant, the method comprising: receiving a data collection privacy profile from a survey or service which has executable instructions to operatively trigger on events or conditions, collect data to be collected, determine conditions upon which data is compiled into a package, and transmit the package to a target specified in the profile.

In an embodiment, the method further includes the steps for the data collection privacy agent confirming that the owner/user has granted permission each profile. In an embodiment, the method also includes receiving a plurality of profiles, and the data collection privacy agent determining a superset of triggers, and upon each trigger, storing the data to be collected. In an embodiment, the method also includes upon determining a condition to package collected data, the data collection agent compiles a package of only the data related to a certain profile provided by a certain survey or service, encrypts it, transmits the encrypted package to a target defined within a profile, and reallocates storage space which is no longer needed.

Reference will now be made to the drawings to describe various aspects of exemplary embodiments of the invention. It should be understood that the drawings are diagrammatic and schematic representations of such exemplary embodiments and, accordingly, are not limiting of the scope of the present invention, nor are the drawings necessarily drawn to scale. In the following description, numerous details are set forth. It wall be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the descriptions, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer systems registers and memories into other data similarly represented as physical quantities within the computer system memories or registers or other such non-transitory information storage, communication circuits for transmitting or receiving, or display devices.

The present invention also relates to apparatus for performing the operations herein. This apparatus may be specifically constructed for the required purposes, or it may comprise application specific integrated circuits which are mask programmable or field programmable, or it may comprise a general purpose processor device selectively activated or reconfigured by a computer program comprising executable instructions and data stored in the computer. Such a computer program may be stored in a non-transitory computer readable storage medium, such as, but not limited to, any type of disk including floppy disks, optical disks, CD-ROMs, magnetic-optical disks, solid state disks, flash memory, read-only memories (ROMs), random access memories (RAMs), EPROMS, EEPROMS, magnetic or optical cards, or any type of non-transitory media suitable for storing electronic instructions, and each coupled to a computer system data communication network.

The algorithms and displays presented herein are not inherently related to any particular computer, circuit, or other apparatus. Various configurable circuits and general purpose systems may be used with programs in accordance with the teachings herein, or it may prove convenient to construct more specialized apparatus to perform the required method steps in one or many processors. The required structure for a variety of these systems will be apparent from the description below. In addition, the present invention is not described with reference to any particular programming language or operating system environment. It will be appreciated that a variety of programming languages, operating systems, circuits, and virtual machines may be used to implement the teachings of the invention as described herein.

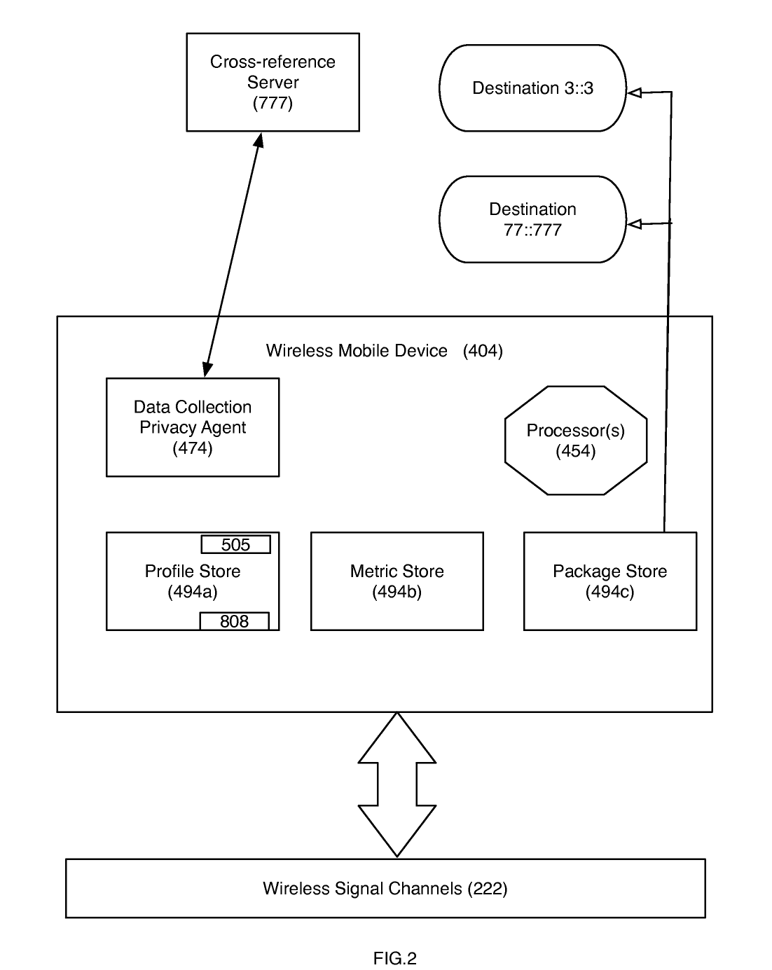

Referring now to FIG. 2, an embodiment of a data collection privacy agent 474 within a wireless mobile device 404 is communicatively coupled to conventional wireless signal channels 222 through which it receives and transmits data using radio technology. In an embodiment this is a cellular telephony network. The wireless mobile device further contains at least one conventional processor 454 and at least one conventional data store 494. In an embodiment, portions of the data store are assigned to store profiles 494a, metrics 494b, and packages 494c. The wireless mobile device of the present invention has at least one data collection privacy agent 474 which may be a circuit or the processor under control of computer instructions when executed by the processor. On the condition that the owner/user of the wireless mobile device has subscribed or agreed to one or more surveys or services, the privacy agent 474 is enabled, initialized, and if necessary installed over the air and receives a first profile and a second profile. A first profile 505 specifies a first condition (RED) upon which certain data (AEIOU) is recorded and stored. A second profile 808 specifies a second condition (HOT) upon which certain data EFGHI is recorded and stored. The first profile also includes a condition (GREEN) upon which to transform the stored data into a package, encrypt it using a seed (MOM), and transmit it to a certain address. The second also includes a condition (COLD) upon which to transform the stored data into a package, encrypt it using a seed (DAD), and transmit it to a different address. The data collection privacy agent 474 checks a cross-reference server 777 to determine which profiles should be downloaded and installed. A computer-readable store contains all the profile conditions, data to be collected, triggers, destinations, and seeds. When the data collection privacy agent determines that a trigger is true, it collects or packages data and if packaged, transmits the package. In an embodiment, the privacy-agent 474 also checks the cross-reference server to verify the subscription or agreement is still in force prior to transmitting to a destination 3::3 or 77:777 the collected data which has been transformed and encrypted into a package.

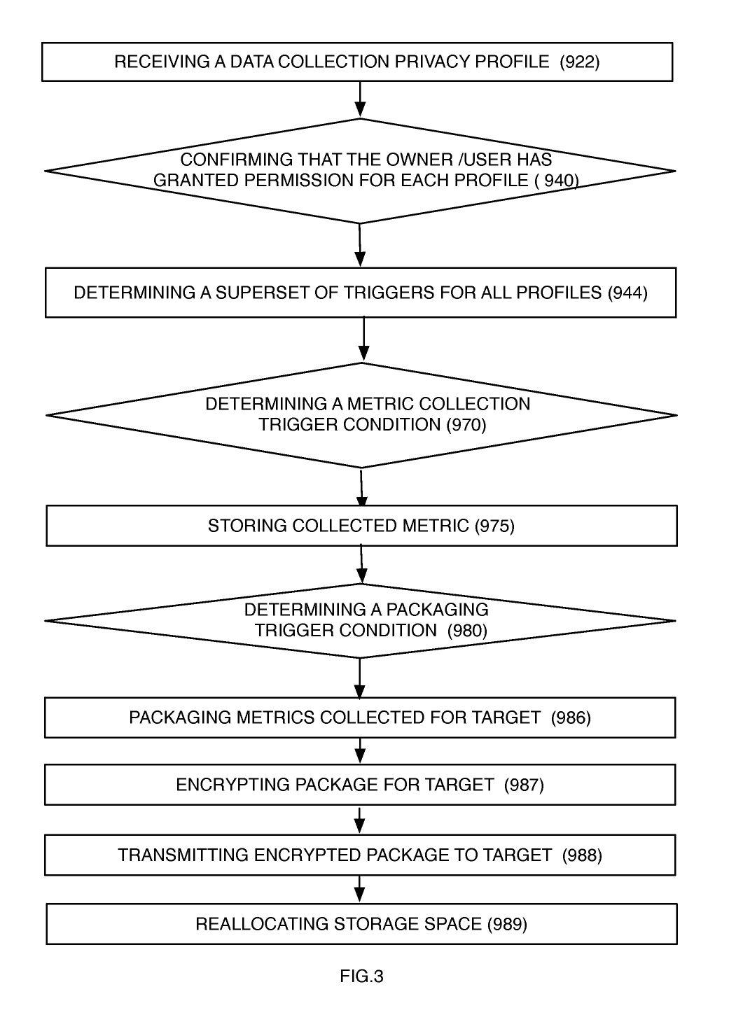

Referring now to FIG. 3, a processor controlled by instructions to perform the steps of a method as follows: receiving a data collection privacy profile 922 from a survey or service which has executable instructions to operatively trigger on events or conditions, collect metrics to be collected, determine conditions upon which metrics are compiled into a package, and transmit the package to a target specified in the profile; confirming that the owner/user has granted permission for each profile 940; determining a superset of triggers 944, and upon determining each trigger condition 970, storing the collected metrics 975; determining a condition to package collected metrics 980; compiling a package of only the metrics related to a certain profile provided by a certain survey or service 986; encrypting it 987; transmitting the encrypted package to a target defined within a profile 988; and reallocating storage space which is no longer needed 989.

### CONCLUSION

The method of operation is easily distinguished from conventional data collection because only the data intended for a specific target is collected and transmitted from the mobile wireless device. The data collection privacy agent operates as a data leak protection filter by preventing measurements of the radio circuits and environment of the device from unconsciously being emitted from the device. Of course the user still may choose to email or text any message or photo or file to any recipient. And the communication carrier has to have the minimum connectivity with its service clients in order for the device to operate. However, value added services are only provided to the users who opt-in.

It is distinguishing characteristic that a profile is authenticated prior to installation. It is a distinguishing characteristic that a profile will be validated with a current private data collection agreement. It is a distinguishing characteristic the data is only collected upon fulfillment of at least one condition specified in a profile. It is a distinguishing characteristic that a package will be compiled only for directed only to a target specified in a profile. It is a distinguishing characteristic that a user may block, obfuscate, mask, hash, or limit the information entropy of data transmitted from the device.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

### An Exemplary Computer System

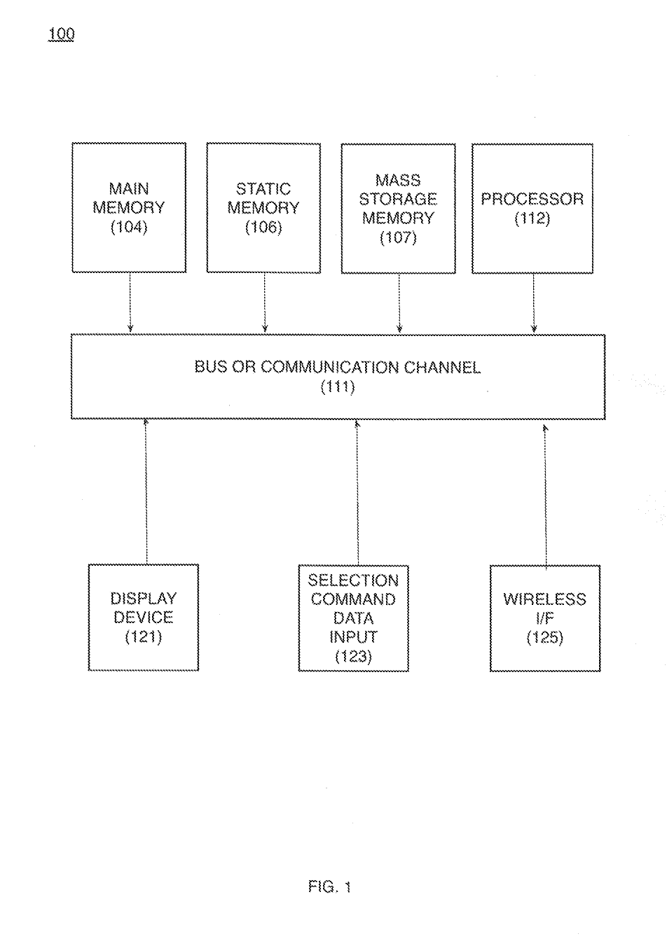

FIG. 1 is a block diagram of an exemplary computer system that may be used to perform one or more of the functions described herein. Referring to FIG. 1, computer system 100 may comprise an exemplary client or server 100 computer system. Computer system 100 comprises a communication mechanism or bus 111 for communicating information, and a processor 112 coupled with bus 111 for processing information. Processor 112 includes a microprocessor, but is not limited to a microprocessor, such as for example, ARM™, Pentium™, etc.

System 100 further comprises a random access memory (RAM), or other dynamic storage device 104 (referred to as main memory) coupled to bus 111 for storing information and instructions to be executed by processor 112. Main memory 104 also may be used for storing temporary variables or other intermediate information during execution of instructions by processor 112.

Computer system 100 also comprises a read only memory (ROM) and/or other static storage device 106 coupled to bus 111 for storing static information and instructions for processor 112, and a non-transitory data storage device 107, such as a magnetic storage device or flash memory and its corresponding control circuits. Data storage device 107 is coupled to bus 111 for storing information and instructions.

Computer system 100 may further be coupled to a display device 121 such a flat panel display, coupled to bus 111 for displaying information to a computer user. Voice recognition, optical sensor, motion sensor, microphone, keyboard, touch screen input, and pointing devices 123 may be attached to bus 111 or a wireless interface 125 for communicating selections and command and data input to processor 112.

Note that any or all of the components of system 100 and associated hardware may be used in the present invention. However, it can be appreciated that other configurations of the computer system may include some or all of the devices in one apparatus, a network, or a distributed cloud of processors.

The embodiments described herein may include the use of a special purpose or general-purpose computer including various computer hardware or software modules, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other non-transitory medium which can be used to store desired program code means in the form of computer-executable instructions or data structures and which can be accessed for execution by a general purpose or special purpose computer to perform a method as disclosed above.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

Those skilled in the art will appreciate that the invention may be practiced in network computing environments with many types of computing system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices or servers that are linked (either by hardwired links, wireless links, or by a combination of hardwired or wireless links) through a communications network. In a distributed computing environment, program modules may be located in both local and remote memory storage devices.

The present invention may also be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. A number of embodiments of the invention have been described. Nevertheless, it will be understood that various modifications may be made without departing from the spirit and scope of the invention. For example, other network topologies may be used. Accordingly, other embodiments are within the scope of the following claims.

We claim:

1. A method for operation of a data collection privacy agent on a mobile wireless device whose owner/user has entered into a private data collection agreement with a service provider or subscribed as a survey participant, the method comprising:
receiving a data collection privacy profile from a survey or service which has executable instructions to operatively trigger on events or conditions, collect metrics to be collected, determine conditions upon which metrics are compiled into a package, and transmit the package to a target specified in the profile.

2. The method further comprising: the data collection privacy agent
confirming that the owner/user has granted permission for each profile.

3. The method further comprising:
receiving a plurality of profiles, and the data collection privacy agent
determining a superset of triggers, and
upon each trigger, storing the metrics to be collected.

4. The method further comprising:
upon determining a condition to package collected metrics, the data collection agent
compiling a package of only the metrics related to a certain profile provided by a certain survey or service,
encrypting it,
transmitting the encrypted package to a target defined within a profile, and
reallocating storage space which is no longer needed.
